(19) United States
(12) Patent Application Publication
(10) Pub. No.: US 2020/0215499 A1
(43) Pub. Date: Jul. 9, 2020

(54) SYSTEM AND METHOD FOR PRODUCING CARBON DIOXIDE-DISSOLVED DEIONIZED WATER

(71) Applicant: TRUSVAL TECHNOLOGY CO. LTD., MIAO-LI HSIEN (TW)

(72) Inventor: SHIH-PAO CHIEN, MIAO-LI HSIEN (TW)

(21) Appl. No.: 16/239,382

(22) Filed: Jan. 3, 2019

(51) Int. Cl. B01F 3/04; B01F 15/00; B01F 5/10; B01F 5/20; B01F 15/04

(52) U.S. Cl. CPC B01F 3/0451; B01F 15/00227; B01F 3/04758; B01F 5/102; B01F 5/20; B01F 2215/008; B01F 15/00155; B01F 15/00136; B01F 15/00344; B01F 15/0429; B01F 2003/04893; B01F 15/00162

(57) ABSTRACT

The present disclosure provides a system for producing carbon dioxide (CO₂)-dissolved deionized water (DIW), the system comprising: a DIW source for providing DIW; a CO₂ source for providing CO₂; a pressurized tank, coupled to the DIW source and the CO₂ source, the pressurized tank being arranged for generating CO₂-dissolved DIW with a first concentration according to the DIW of the DIW source and the CO₂ of the CO₂ source; a mixer, coupled to the DIW source and the pressurized tank, the mixer being arranged for generating CO₂-dissolved DIW with a second concentration according to the CO₂-dissolved DIW with the first concentration and the DIW of the DIW source; and wherein the second concentration is lower than the first concentration.

### FIELD

This disclosure relates generally to carbon dioxide (CO₂)-dissolved deionized water (DIW) and, in particular, to a system and a method for producing CO₂-dissolved DIW.

### BACKGROUND

Existing CO₂-dissolved DIW producing systems dissolve CO₂ in DIW to a required concentration directly, without a diluting operation, and therefore the existing systems are not flexible because adjusting the concentration of the CO₂-dissolved DIW is inconvenient when a different concentration is required.

### SUMMARY OF THE DISCLOSURE

One aspect of the present disclosure provides a system for producing carbon dioxide (CO₂)-dissolved deionized water (DIW), the system including: a DIW source for providing DIW; a CO₂ source for providing CO₂; a pressurized tank, coupled to the DIW source and the CO₂ source, the pressurized tank being arranged for generating CO₂-dissolved DIW with a first concentration according to the DIW of the DIW source and the CO₂ of the CO₂ source; and a mixer, coupled to the DIW source and the pressurized tank, the mixer being arranged for generating CO₂-dissolved DIW with a second concentration according to the CO₂-dissolved DIW with the first concentration and the DIW of the DIW source; wherein the second concentration is lower than the first concentration.

In an embodiment, the system further includes a liquid level sensor coupled to the pressurized tank for monitoring a liquid level of the DIW in the pressurized tank.

In an embodiment, the system further includes a pressure sensor coupled to the pressurized tank for monitoring the pressure of the CO₂ in the pressurized tank above a liquid level of the DIW.

In an embodiment, the system further includes a first conductivity monitor unit coupled to the pressurized tank for monitoring a conductivity of the CO₂-dissolved DIW in the pressurized tank.

In an embodiment, the system further includes a second conductivity monitor unit coupled to the mixer for monitoring a conductivity of the CO₂-dissolved DIW in the mixer.

In an embodiment, the CO₂-dissolved DIW with the first concentration is a saturated solution.

In an embodiment, the system further includes a pump set, including: a pump; a liquid inlet tube, with one end coupled to the pump and the other end coupled to the pressurized tank for sucking the CO₂-dissolved DIW in the pressurized tank through the pump; a gas sucking tube, with one end coupled to the liquid inlet tube and the other end coupled to the pressurized tank for sucking the CO₂ in the pressurized tank through the pump; a liquid outlet tube, with one end coupled to the pump and the other end coupled to a diffuser in the pressurized tank for transporting the sucked CO₂-dissolved DIW and CO₂ to the pressurized tank; and the diffuser, for diffusing the sucked CO₂-dissolved DIW and CO₂ to the pressurized tank.

In an embodiment, the pump set further includes a second gas sucking tube, with one end coupled to the liquid inlet tube and the other end coupled to the mixer for sucking the CO₂ in the mixer through the pump.

Another aspect of the present disclosure provides a method for producing CO₂-dissolved DIW, which includes: providing DIW; providing CO₂; generating CO₂-dissolved DIW with a first concentration in a pressurized tank according to the DIW and the CO₂; and generating CO₂-dissolved DIW with a second concentration in a mixer according to the CO₂-dissolved DIW with the first concentration and the DIW; wherein the second concentration is lower than the first concentration.

In an embodiment, the method further includes determining the first concentration.

In an embodiment, the method further includes determining the second concentration.

In an embodiment, the method further includes monitoring the liquid level of the DIW in the pressurized tank.

In an embodiment, the method further includes predetermining the pressure of the CO₂ above the liquid level in the pressurized tank for generating CO₂-dissolved DIW with the first concentration.

In an embodiment, the method further includes monitoring the pressure of the CO₂ in the pressurized tank above the liquid level of the DIW.

In an embodiment, the method further includes monitoring the conductivity of the CO₂-dissolved DIW in the pressurized tank.

In an embodiment, the method further includes monitoring the conductivity of the CO₂-dissolved DIW in the mixer.

In an embodiment, the CO₂-dissolved DIW with the first concentration is a saturated solution.

In an embodiment, the method further includes monitoring the first flow rate of the DIW source to the mixer and monitoring the second flow rate of the CO₂-dissolved DIW with the first concentration to the mixer.

In an embodiment, the method further includes sucking the CO₂ in the pressurized tank, and sucking the CO₂-dissolved DIW in the pressurized tank.

In an embodiment, the method further includes sucking the CO₂ in the mixer.

In the present disclosure, the system adopts at least two operations or phases to produce the CO₂-dissolved DIW, with the second concentration as the final product. In contrast, existing CO₂-dissolved DIW-producing systems dissolve CO₂ in DIW to a required concentration directly, without a diluting operation. The existing systems are not flexible, because adjusting the concentration of the CO₂-dissolved DIW is inconvenient when a different concentration is required. In the present disclosure, when CO₂-dissolved DIW of the second concentration is needed, the proposed system can generate CO₂-dissolved DIW of the second concentration by diluting the CO₂-dissolved DIW with the first concentration prepared in advance. Since the diluting operation is normally faster than the dissolving operation, the productivity is therefore higher than that of existing systems.

### BRIEF DESCRIPTION OF THE DRAWINGS

Aspects of the present disclosure are best understood from the following detailed description when read with the accompanying figures.

FIG. 1 illustrates a system for producing CO₂-dissolved DIW in which a CO₂-dissolved DIW-producing technique is implemented in accordance with a first embodiment of the present disclosure.

FIG. 2 illustrates a system for producing CO₂-dissolved DIW in which a CO₂-dissolved DIW-producing technique is implemented in accordance with a second embodiment of the present disclosure.

FIG. 3 illustrates a system for producing CO₂-dissolved DIW in which a CO₂-dissolved DIW-producing technique is implemented in accordance with a third embodiment of the present disclosure.

FIG. 4 is a flowchart of an illustrative method for the CO₂-dissolved DIW producing system in accordance with various embodiments of the present disclosure.

### DETAILED DESCRIPTION OF THE INVENTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or to configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

The exemplary embodiments may be further understood with reference to the following description and the related appended drawings, wherein like elements are provided with the same reference numerals.

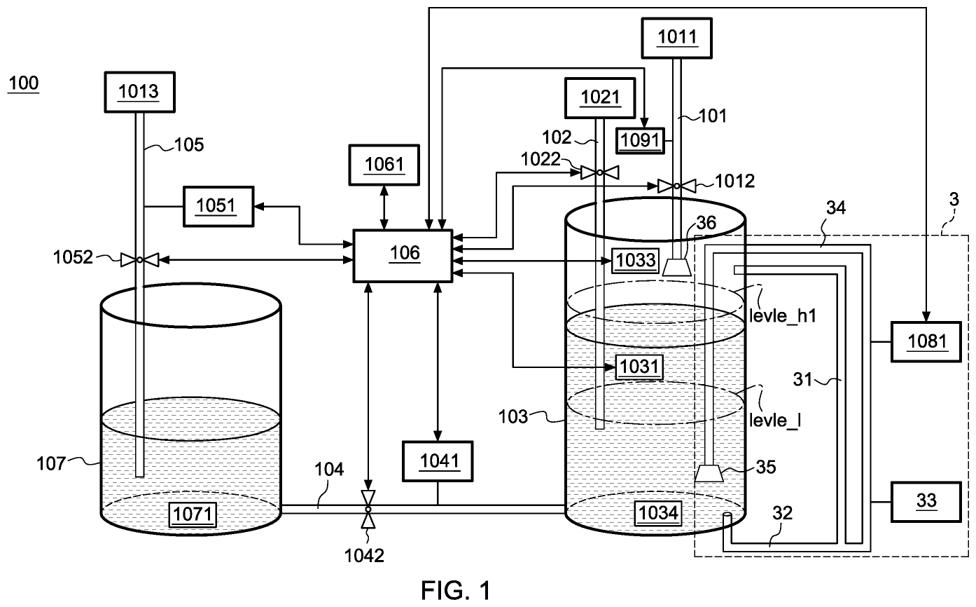

FIG. 1 illustrates a system 100 for producing CO₂-dissolved deionized to water (DIW), in accordance with an embodiment of the present disclosure.

As used herein, the term “DIW” generally refers to water without mineral ions, or including only a small amount of mineral ions. For example, the mineral ions at least include cations (such as sodium, calcium, iron, and copper) and anions (such as chloride and sulfate).

In chemistry, Henry's law is a gas law that states that the amount of dissolved gas is proportional to its partial pressure in the gas phase, and therefore the concentration of the solution is proportional to its partial pressure in the gas phase. Based on Henry's law, the system 100 adjusts the concentration of the CO₂-dissolved DIW by controlling the pressure of the CO₂.

One of the operations, i.e. the first operation, of the system 100 is used to dissolve CO₂ in DIW to produce CO₂-dissolved DIW with a first concentration in a pressurized tank 103. In an embodiment, the produced CO₂-dissolved DIW is saturated and the first concentration is the maximum concentration. In other words, no additional CO₂ can be dissolved in the saturated CO₂-dissolved DIW. In some embodiments, the CO₂-dissolved DIW is unsaturated but the first concentration is higher than about 0.033 mol/L. Another operation, i.e. a second operation, of the system 100 is used to dilute the CO₂-dissolved DIW with the first concentration to produce CO₂-dissolved DIW with a second concentration lower than the first concentration. In many instances, the CO₂-dissolved DIW of the second concentration is a final product of the system 100.

As mentioned above, the system 100 adopts at least two operations or phases to produce the CO₂-dissolved DIW, with the second concentration as the final product. In contrast, existing CO₂-dissolved DIW-producing systems dissolve CO₂ in DIW to a required concentration directly, without a diluting operation. The existing systems are not flexible because adjusting the concentration of the CO₂-dissolved DIW is inconvenient when a different concentration is required. In the present disclosure, when CO₂-dissolved DIW of the second concentration is needed, the proposed system 100 can generate CO₂-dissolved DIW of the second concentration by diluting the CO₂-dissolved DIW with the first concentration prepared in advance. Since the diluting operation is normally faster than the dissolving operation, the productivity is therefore higher than that of existing systems.

As shown in FIG. 1, the system 100 includes a pressurized tank 103, a mixer 107 and a tube 104. One end of the tube 104 is coupled to the pressurized tank 103; and the other end of the tube 104 is coupled to the mixer 107. In this way, the tube 104 is between the pressurized tank 103 and the mixer 107. In an embodiment, the pressurized tank 103 and the mixer 107 are in a solid geometric figure with straight parallel sides and a circular or oval section. For example, the pressurized tank 103 and the mixer 107 are in a cylinder shape. However, this is not a limitation of the present disclosure.

The system 100 further includes another tube 101 with one end coupled to a nozzle 36 inserted into the pressurized tank 103 and the other end coupled to a DIW source 1011. The nozzle 36 is configured to spray DIW in a wide rage in order to help the DIW to be evenly distributed in the pressurized tank 103 and increase contact area of the DIW. In some embodiments, the nozzle 36 may include a diffuser to atomizing DIW. In some embodiments, the nozzle 36 may include a water film nozzle to generate DIW film. A valve 1012 is coupled to the tube 101 at a predetermined location of the tube 101 to determine a flow condition of DIW from the DIW source 1011 to the pressurized tank 103. In many instances, the predetermined location is between the DIW source 1011 and the pressurized tank 103. In some embodiments, the predetermined location is above the pressurized tank 103 and closer to the DIW source 1011 than the pressurized tank 103. In particular, the valve 1012 is configured to at least control the flow condition of the DIW stream flowing through the tube 101 from the DIW source 1011 by opening, closing, or partially obstructing a passageway of the tube 101. In many instances, the valve 1012 may be further coupled to a controller 106 to facilitate automatic control of the valve 1012 by the controller 106 during the first operation. In an embodiment, the valve 1012 is an electronic valve in communication with the controller 106 (e.g., via electronic wiring or wireless link) to facilitate automatic control of the valve 1012 by the controller 106 during the first operation.

A meter 1091 is coupled to the tube 101 at a predetermined location of the tube 101 for at least detecting the flow rate of the DIW stream flowing through the tube 101 from the DIW source 1011. The meter 1091 is further coupled to the controller 106 for providing the flow rate of the DIW stream. In an embodiment, the meter 1091 is an electronic flow meter in communication with the controller 106 (e.g., via electronic wiring or wireless link) for providing the flow rate of the DIW stream flowing through the tube 101.

The system 100 further includes a liquid level sensor 1031 coupled to the pressurized tank 103 for monitoring a liquid level of the DIW in the pressurized tank 103. For example, the liquid level sensor 1031 may be used to monitor a height of the liquid level of the DIW stored in the pressurized tank 103 in order to obtain information of a stored amount of the DIW in the pressurized tank 103. The liquid level sensor 1031 is further coupled to the controller 106 to provide the information of the stored amount of the DIW in the pressurized tank 103 to the controller 106 during the first operation. In an embodiment, the liquid level sensor 1031 is an electronic sensor in communication with the controller 106 (e.g., via electronic wiring or wireless link) for providing the information of the stored amount of the DIW in the pressurized tank 103 to the controller 106 during the first operation.

In an embodiment, the liquid level of the produced CO₂-dissolved DIW in the pressurized tank 103 is controlled to between a maximum liquid level level_h1 and a minimum liquid level level_1 as indicated in FIG. 1. In some embodiments, volume of a first portion between a top of the pressurized tank 103 and the maximum liquid level level_h1 is about 30% to about 33% of the overall volume of the pressurized tank 103; volume of a second portion between the maximum liquid level level_h1 and the minimum liquid level level_1 is about 30% to about 37% of the overall volume of the pressurized tank 103; and volume of a third portion between the minimum liquid level level_1 and a bottom of the pressurized tank 103 is about 30% to about 64% of the overall volume of the pressurized tank 103.

The DIW source 1011 serves as a source to provide DIW. When the liquid level sensor 1031 detects that the location or the height of the DIW stored in the pressurized tank 103 is lower than the minimum liquid level level_1, the controller 106 issues a command to the valve 1012 to open for delivering DIW into the pressurized tank 103 through the tube 101 from the DIW source 1011. When the liquid level sensor 1031 detects that the liquid level of the DIW in the pressurized tank 103 reaches the maximum liquid level level_h1, the controller 106 issues another command to the valve 1012 to close for the purpose of ceasing to deliver DIW into the pressurized tank 103 through the tube 101 from the DIW source 1011. In an embodiment, the nozzle 36 is configured to above the maximum liquid level level_h1.

The system further includes another tube 102 with one end coupled to the pressurized tank 103 and the other end coupled to a CO₂ source 1021. The CO₂ source 1021 serves as a source to provide CO₂. A valve 1022 is coupled to the tube 102 at a predetermined location of the tube 102. In an embodiment, the predetermined location is above the pressurized tank 103 or is very close to the CO₂ source 1021. The valve 1022 is configured to at least control the flow condition of the CO₂ flowing through the tube 102 by opening, closing, or partially obstructing a passageway of the tube 102. The valve 1022 is further coupled to the controller 106 for facilitating automatic control of the valve 1022 by the controller 106 during the first operation.

In an embodiment, the valve 1022 is an electronic valve in communication with the controller 106 (e.g., via electronic wiring or wireless link) to control the flow condition of the CO₂ flowing through the tube 102 from the CO₂ source 1021.

The system 100 further includes a pressure sensor 1033 coupled to the pressurized tank 103 for monitoring the pressure of the CO₂ in the pressurized tank 103 above the liquid level of the DIW. In particular, the pressure sensor 1033 is coupled to a location of the pressurized tank 103 which is higher than the maximum liquid level level_h1. In that way, it is guaranteed that the pressure of the CO₂ above the liquid level of the DIW can be measured. The pressure sensor 1033 is further coupled to the controller 106 for providing the measurement of the pressure of the CO₂ in the pressurized tank 103 above the liquid level of the DIW to the controller 106 during the first operation. In an embodiment, the pressure sensor 1033 is an electronic pressure sensor in communication with the controller 106 (e.g., via electronic wiring or wireless link) for providing the measurement of the pressure of the CO₂ in the pressurized tank 103 above the liquid level of the DIW to the controller 106 during the first operation. When the pressure sensor 1033 detects that the measurement of the pressure of the CO₂ in the pressurized tank 103 above the liquid level of the DIW reaches a predetermined threshold, the controller 106 issues a command to the valve 1022 to stop delivering CO₂ into the pressurized tank 103. In an embodiment, the threshold is 5 atm. This threshold is selected because when the temperature of the pressurized tank 103 is 25 degrees Celsius and the pressure of the CO₂ in the pressurized tank 103 above the liquid level of the DIW is 5 atm, the CO₂-dissolved DIW is saturated solution.

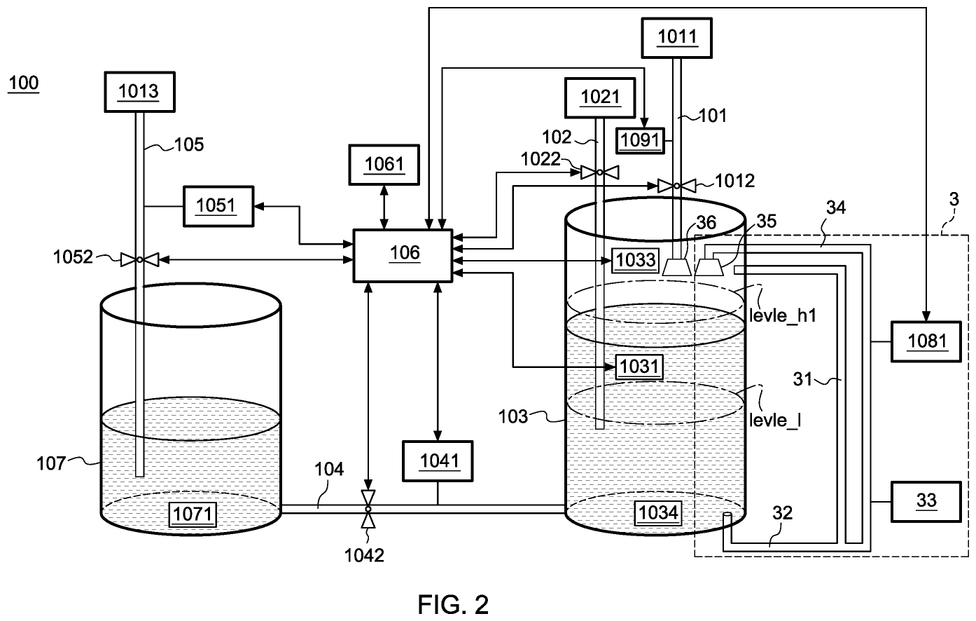

The system 100 further includes a pump set 3, which includes a tube 31, a tube 32, a tube 34, a pump 33 and a nozzle 35. One end of the tube 31 is coupled to the tube 32 at a location of the tube 32 and the other end of the tube 31 is coupled to the pressurized tank 103 at a location on the pressurized tank 103 that is above the liquid level of the DIW, in particular, above the maximum liquid level level_h1. One end of the tube 32 is coupled to the pump 33 at a first location of the pump 33 and the other end of the tube 32 is coupled to the pressurized tank 103 around a bottom of the pressurized tank 103. In some embodiments, the other end of the tube 32 is coupled to the pressurized tank 103 at a location in the bottom of the pressurized 30o tank 103. One end of the tube 34 is coupled to the nozzle 35 and the other end of the tube 34 is coupled to the pump 33 at a second location of the pump 33. In an embodiment of FIG. 1, the nozzle 35 is configured to be disposed below the minimum liquid level level_1. However, this is not a limitation of the present disclosure. In another embodiment of FIG. 2, the nozzle 35 of a system 200 is configured to be disposed above the maximum liquid level level_h1.

A meter 1081 is coupled to the tube 34 at a predetermined (or first) location of the tube 34 for at least detecting the flow rate of the tube 34. In an embodiment, the meter 1081 is an electronic flow meter in communication with the controller 106 (e.g., via electronic wiring or wireless link)

The pump 33 further includes a vane for providing vane centrifugal pressurization. When the pump 33 operates, the tube 32 transports CO₂-dissolved to DIW to the pump 33, the CO₂ in the pressurized tank 103 above the liquid level of the DIW is sucked in through the tube 31, the CO₂-dissolved DIW and the CO₂ in the pressurized tank 103 above the liquid level of the DIW is transported by the tube 34 and the nozzle 35 sprays the CO₂-dissolved DIW and the CO₂ and generates a large amount of bubbles inside the CO₂-dissolved DIW. The nozzle 35 is configured to spray the mixture of the CO₂-dissolved DIW and the CO₂ in a wide rage in order to help the CO₂-dissolved DIW and the CO₂ to be evenly distributed in the pressurized tank 103. In some embodiments, the nozzle 35 may include a diffuser to atomizing the mixture of the CO₂-dissolved DIW and the CO₂. In some embodiments, the nozzle 35 may include a water film nozzle to generate a film of the mixture of the CO₂-dissolved DIW and the CO₂. Because the pump 33 operates by vane centrifugal pressurization, the vane can further break down the bubbles into smaller bubbles during the vane centrifugal pressurization, and therefore the operation of the pump set 3 increases the surface area of the bubbles to facilitate improved dissolving of CO₂ in the DIW.

The pressurized tank 103 is used for dissolving CO₂ in the DIW and is also used for storing the CO₂-dissolved DIW with the first concentration.

The conductivity of CO₂-dissolved DIW is proportional to the concentration of CO₂-dissolved DIW, and therefore the system 100 may further include a conductivity monitor unit 1034 coupled to the pressurized tank 103; for instance, on the bottom of the pressurized tank 103 for monitoring the conductivity of the CO₂-dissolved DIW in the pressurized tank 103. In an embodiment wherein the produced CO₂-dissolved DIW is saturated and the first concentration is the maximum concentration, the conductivity of the CO₂-dissolved DIW with the first concentration is about 107 μS/cm at 25 degrees Celsius.

One of the purposes of the mixer 107 is for diluting the CO₂-dissolved DIW with the first concentration by the DIW to produce the CO₂-dissolved DIW with the second concentration.

The system 100 further includes a tube 105 with one end coupled to the mixer 107 and the other end coupled to the DIW source 1013. However, this is not a limitation of the present disclosure. In some embodiments, the mixer 107 and the pressurized tank 103 may shared the same DIW source 1011. A meter 1051 is coupled to the tube 105 at a predetermined (or first) location of the tube 105 for at least detecting the flow rate of the DIW stream flowing through the tube 105 from the DIW source 1013. The meter 1051 is further coupled to the controller 106 for providing the flow rate of the DIW stream flowing through the tube 105 from the DIW source 1013 to the controller 106 during the second operation. In an embodiment, the meter 1051 is an electronic flow meter in communication with the controller 106 (e.g., via electronic wiring or wireless link) for providing the flow rate of the DIW stream flowing through the tube 105 from the DIW source 1013 to the controller 106 during the second operation.

A valve 1052 is coupled to the tube 105 at another predetermined (or a second) location of the tube 105. The valve 1052 is configured to at least control the flow condition of the DIW stream flowing through the tube 105 from the DIW source 1013 by opening, closing, or partially obstructing a passageway of the tube 105. The valve 1052 is further coupled to the controller 106 for controlling the flow condition of the DIW stream flowing through the tube 105 from the DIW source 1013 by the controller 106 during the second operation. In some embodiments, the second location is configured to be between the first location and the end of the tube 105. In some embodiments, the first location and the second location are above the pressurized tank 103. In an embodiment, the valve 1052 is an electronic valve in communication with the controller 106 (e.g., via electronic wiring or wireless link) to facilitate automatic control of the valve 1052 by the controller 106 during the second operation. In an embodiment, the valve 1052 is a proportional control valve (PCV).

One end of the tube 104 is coupled to the mixer 107 and the other end of the tube 104 is coupled to the pressurized tank 103. A meter 1041 is coupled to the tube 104 at a predetermined (or first) location of the tube 104 for at least detecting the flow rate of the CO₂-dissolved DIW with the first concentration flowing through the tube 104 from the pressurized tank 103. In an embodiment, the flow rate of the CO₂-dissolved DIW and the CO₂ transported by the tube 34 is not less than the flow rate of the CO₂-dissolved DIW flowing through the tube 104 from the pressurized to tank 103. In an embodiment, the flow rate of the CO₂-dissolved DIW and the CO₂ transported by the tube 34 is greater than about 1.3 times the flow rate of the CO₂-dissolved DIW flowing through the tube 104 from the pressurized tank 103. In an embodiment, the flow rate of the DIW stream flowing through the tube 101 is not less than the flow rate of the CO₂-dissolved DIW flowing through the tube 104 from the pressurized tank 103. In an embodiment, the flow rate of the DIW stream flowing through the tube 101 is greater than about 1.3 times the flow rate of the CO₂-dissolved DIW flowing through the tube 104 from the pressurized tank 103.

In an embodiment, the meter 1041 is an electronic flow meter in communication with the controller 106 (e.g., via electronic wiring or wireless link) for providing the flow rate of the CO₂-dissolved DIW with the first concentration stream flowing through the tube 104 to the controller 106 during the second operation. A valve 1042 is coupled to the tube 104 at another predetermined (or a second) location of the tube 104. The valve 1042 is configured to at least control the flow condition of the CO₂-dissolved DIW with the first concentration stream flowing through the tube 104 from the pressurized tank 103 by opening, closing, or partially obstructing a passageway of the tube 104. In an embodiment, the valve 1042 is an electronic valve in communication with the controller 106 (e.g., via electronic wiring or wireless link) to facilitate automatic control of the valve 1042 by the controller 106 during the second operation. In an embodiment, the valve 1042 is a proportional control valve (PCV). In an embodiment, the second location is configured to be between the first location and the end of the tube 104.

In an embodiment, the controller 106 processes the flow rate measured by the meter 1041 and the meter 1051. The controller 106 issues a command to control the flow condition of the CO₂-dissolved DIW with the first concentration flowing through the tube 104 from the pressurized tank 103 by controlling the valve 1042 to open, close, or partially obstruct a passageway of the tube 104. The controller 106 also issues another command to control the flow condition of the DIW stream flowing through the tube 105 from the DIW source 1013 by controlling the valve 1052 to open, close, or partially obstruct a passageway of the tube 105. Controlling the flow condition of the CO₂-dissolved DIW with the first concentration flowing through the tube 104 and controlling the flow condition of the DIW stream flowing through the tube 105 into the mixer 107 produces the CO₂-dissolved DIW with the second concentration.

In an embodiment, the controller 106 further includes a setting module 1061 for setting or programming the first concentration and the second concentration. The setting module 1061 communicates with the controller 106 (e.g., via electronic wiring or wireless link).

Controlling the flow condition of the CO₂-dissolved DIW with the first concentration flowing through the tube 104 by controlling the valve 1042 and controlling the flow condition of the DIW stream flowing through the tube 105 by controlling the valve 1052 produces the CO₂-dissolved DIW with a designated concentration. In order to provide a monitoring mechanism to provide redundant measurement of the obtained CO₂-dissolved DIW with the designated concentration, in some embodiments, the system 100 may further include a conductivity monitor unit 1071 coupled to the mixer 107 for monitoring the conductivity of the CO₂-dissolved DIW in the mixer 107. In an embodiment, the conductivity monitor unit 1071 is coupled to the mixer 107 at a location in the bottom of the mixer 107. In an embodiment, the conductivity of the CO₂-dissolved DIW with the second concentration is 33 μS/cm. In an embodiment, the conductivity of the CO₂-dissolved DIW with the second concentration is between 31 μS/cm and 35 μS/cm. In an embodiment, the conductivity of the CO₂-dissolved DIW with the second concentration is 10 μS/cm and 90 μS/cm.

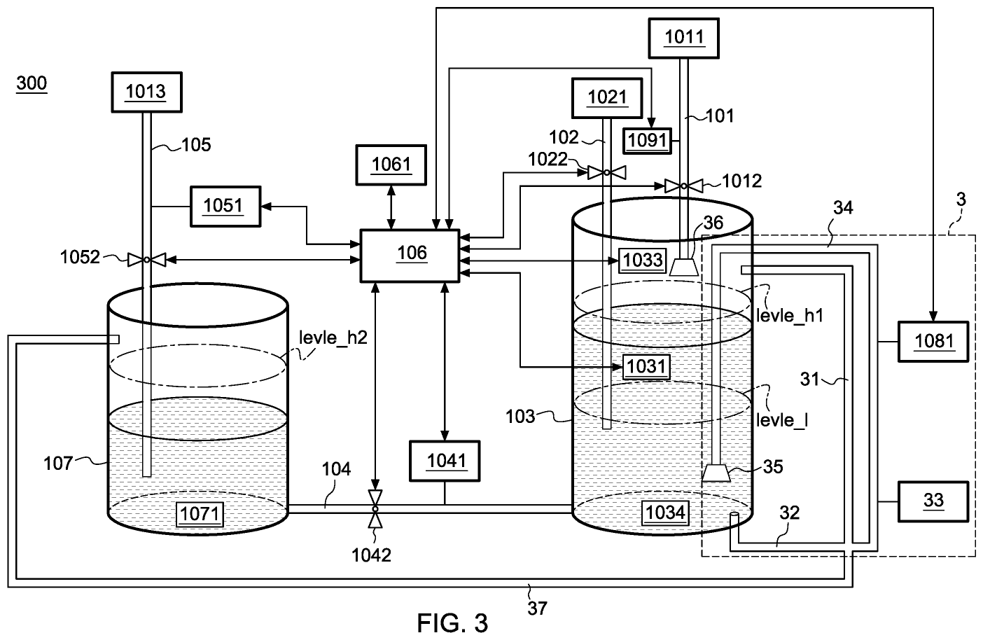

An embodiment of FIG. 3, a system 300 further includes a tube 37 in order to recycle and reuse the CO₂ in the mixer 107 above the liquid level of the diluted CO₂-dissolved DIW. One end of the tube 37 is coupled to the tube 31 and the tube 32, and the other end of the tube 37 is coupled to the mixer 107 at a location on the mixer 107 that is above the liquid level of the DIW, in particular, above a maximum liquid level level_h2. When the pump 33 operates, the tube 32 transports CO₂-dissolved DIW to the pump 33, the CO₂ in the mixer 107 above the liquid level of the diluted CO₂-dissolved DIW is sucked in through the tube 37. The CO₂ in the mixer 107 above the liquid level, the CO₂ in the pressurized tank 103 above the liquid level and the CO₂-dissolved DIW are transported by the tube 34 and sprayed by the nozzle 35.

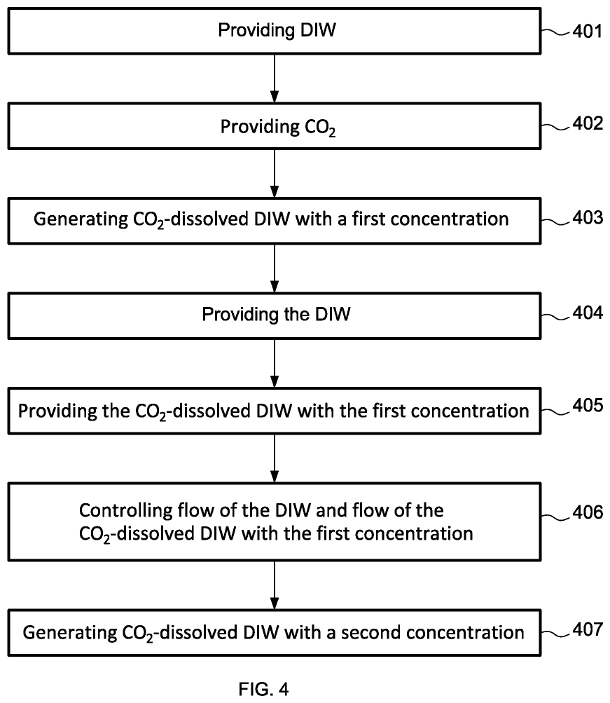

FIG. 4 is a flowchart of an illustrative method 400 for producing CO₂-dissolved DIW in accordance with an embodiment.

The flowchart illustrates a method 400 that includes step 401: providing DIW, step 402 providing CO₂, step 403: generating CO₂-dissolved DIW with a first concentration, step 404: providing the DIW, step 405: providing the CO₂-dissolved DIW with the first concentration, step 406: controlling the flow of the DIW and the flow of the CO₂-dissolved DIW with the first concentration, and step 407: generating CO₂-dissolved DIW with a second concentration.

The method 400 includes at least two operations or phases. A first operation or phase includes step 401 to step 403. The first operation or phase is used to produce the CO₂-dissolved DIW with the first concentration as mentioned above regarding the operation of the pressurized tank 103. The second operation or phase includes step 404 to step 407. The second operation or phase is used to produce the CO₂-dissolved DIW with the second concentration as mentioned above, regarding the operation of the mixer 107.

In an embodiment, at step 401, the DIW source 1011 serves as a source to provide DIW. When the liquid level sensor 1031 detects that the liquid level of the DIW in the pressurized tank 103 is lower than a first liquid level, the controller 106 issues a command to the valve 1012 to open, in order to deliver the DIW into the pressurized tank 103. When the liquid level sensor 1031 detects that the liquid level of the DIW in the pressurized tank 103 reaches a second liquid level, the controller 106 issues another command to the valve 1012 to close in order to stop delivering the DIW into the pressurized tank 103. In an embodiment, the second liquid level is higher than the first liquid level.

In an embodiment, in step 402, the CO₂ source 1021 serves as a source to provide the CO₂. The CO₂ provided by the CO₂ source 1021 is gaseous or liquid.

In an embodiment, the pressure sensor 1033 is disposed in the pressurized tank 103 for monitoring the pressure of the CO₂ in the pressurized tank 103 above the liquid level of the DIW. When the measurement of the pressure of the CO₂ inside the pressurized tank 103 reaches a predetermined threshold, the controller 106 issues a command to the tube 102 to stop delivering CO₂ into the pressurized tank 103. In an embodiment, the threshold is 5 atm. This threshold is selected because when the temperature of the pressurized tank 103 is 25 degrees Celsius and the pressure of the CO₂ in the pressurized tank 103 above the liquid level of the DIW is 5 atm, the concentration of CO₂-dissolved DIW is greater than the concentration at 1 atm.

In an embodiment, at step 403 the CO₂ dissolves in the DIW and generates CO₂-dissolved DIW with a first concentration based on the DIW and the CO₂.

As mentioned above, the method 400 produces the CO₂-dissolved DIW with the first concentration by implementing step 401 to step 403.

The second operation or phase begins at step 404. At step 404, the tube 105 delivers the DIW into the mixer 107. In an embodiment, the meter 1051 monitors the flow rate of the DIW stream flowing through the tube 105 from the DIW source.

At step 405, the tube 104 delivers the CO₂-dissolved DIW with the first concentration into the mixer 107. In an embodiment, the meter 1041 monitors the flow rate of the CO₂-dissolved DIW with the first concentration flowing through the tube 104 from the pressurized tank 103.

At step 406, the controller 106 controls the flow condition of the DIW stream flowing through the tube 105 from the DIW source by controlling the valve 1052 to open, close, or partially obstruct a passageway of the tube 105. The controller 106 controls the flow condition of the CO₂-dissolved DIW with the first concentration flowing through the tube 104 from the pressurized tank 103 by controlling the valve 1042 to open, close, or partially obstruct a passageway of the tube 104. In an embodiment, the valve 1052 and the valve 1042 are proportional control valves (PCV).

In an embodiment, the valve 1052 and the valve 1042 are electronic valves in communication with the controller 106 (e.g., via electronic wiring or wireless link) to facilitate automatic control of the valve 1052 and the valve 1042 by the controller 106 during the second operation.

In an embodiment, the method 400 may further utilize the setting module 1061 for setting or programming the first concentration and the second concentration. The setting module 1061 communicates with the controller 106 (e.g., via electronic wiring or wireless link).

At step 407, in an embodiment, the mixer 107 is used for diluting the CO₂-dissolved DIW with the first concentration by the DIW for producing the CO₂-dissolved DIW with the second concentration.

The method 400 produces the CO₂-dissolved DIW with the second concentration by implementing step 404 to step 408.

It should be understood that method 400 of FIG. 4 is merely illustrative. Any of the steps may be removed, modified, or combined, and any additional steps may be added, without departing from the scope of the invention.

What is claimed is:

1. A system for producing carbon dioxide (CO₂)-dissolved deionized water (DIW), the system comprising:
a DIW source for providing DIW;
a CO₂ source for providing CO₂;
a pressurized tank, coupled to the DIW source and the CO₂ source, the pressurized tank being arranged for generating CO₂-dissolved DIW with a first concentration according to the DIW of the DIW source and the CO₂ of the CO₂ source; and
a mixer, coupled to the DIW source and the pressurized tank, the mixer being arranged to for generating CO₂-dissolved DIW with a second concentration according to the CO₂-dissolved DIW with the first concentration and the DIW of the DIW source;
wherein the second concentration is lower than the first concentration.

2. The system of claim 1, further comprising a liquid level sensor coupled to the pressurized tank for monitoring a liquid level of the DIW in the pressurized tank.

3. The system of claim 1, further comprising a pressure sensor coupled to the pressurized tank for monitoring the pressure of the CO₂ in the pressurized tank above a liquid level of the DIW.

4. The system of claim 1, further comprising a first conductivity monitor unit coupled to the pressurized tank for monitoring a conductivity of the COz-dissolved DIW in the pressurized tank.

5. The system of claim 1, further comprising a second conductivity monitor unit coupled to the mixer for monitoring a conductivity of the CO₂-dissolved DIW in the mixer.

6. The system of claim 1, wherein the CO₂-dissolved DIW with the first concentration is a saturated solution.

7. The system of claim 1, further comprising:
a pump set, comprising:
a pump;
a liquid inlet tube, with one end coupled to the pump and the other end coupled to the pressurized tank for sucking the CO₂-dissolved DIW in the pressurized tank through the pump;
a first gas sucking tube, with one end coupled to the liquid inlet tube and the other end coupled to the pressurized tank for sucking the CO₂ in the pressurized tank through the pump;
a liquid outlet tube, with one end coupled to the pump and the other end coupled to a nozzle in the pressurized tank for transporting the sucked CO₂-dissolved DIW and CO₂ to the pressurized tank; and
the nozzle, for spraying the sucked CO₂-dissolved DIW and CO₂ to the pressurized tank.

8. The system of claim 7, wherein the pump set further comprises:
a second gas sucking tube, with one end coupled to the liquid inlet tube and the other end coupled to the mixer for sucking the CO₂ in the mixer through the pump.

9. A method for producing carbon dioxide (CO₂)-dissolved deionized water (DIW), comprising:
providing DIW;
providing CO₂;
generating CO₂-dissolved DIW with a first concentration in a pressurized tank according to the DIW and the CO₂; and
generating CO₂-dissolved DIW with a second concentration in a mixer according to the CO₂-dissolved DIW with the first concentration and the DIW;
wherein the second concentration is lower than the first concentration.

10. The method of claim 9, further comprising determining the first concentration.

11. The method of claim 9, further comprising determining the second concentration.

12. The method of claim 9, further comprising monitoring a liquid level of the DIW in the pressurized tank.

13. The method of claim 12, further comprising predetermining a pressure of the CO₂ above the liquid level in the pressurized tank for generating CO₂-dissolved DIW with the first concentration.

14. The method of claim 12, further comprising monitoring a pressure of the CO₂ in the pressurized tank above the liquid level of the DIW.

15. The method of claim 9, further comprising monitoring a conductivity of the CO₂-dissolved DIW in the pressurized tank.

16. The method of claim 9, further comprising monitoring a conductivity of the CO₂-dissolved DIW in the mixer.

17. The method of claim 9, wherein the CO₂-dissolved DIW with the first concentration is a saturated solution.

18. The method of claim 9, further comprising monitoring a first flow rate of the DIW source to the mixer and a second flow rate of the CO₂-dissolved DIW with the first concentration to the mixer.

19. The method of claim 9, further comprising:
sucking the CO₂ in the pressurized tank; and
sucking the CO₂-dissolved DIW in the pressurized tank.

20. The method of claim 19, further comprising:
sucking the CO₂ in the mixer.
